(19) United States
(12) Patent Application Publication
(10) Pub. No.: US 2016/0019538 A1
(43) Pub. Date: Jan. 21, 2016

(54) Transaction Authorization Employing Drag-And-Drop of a Security-Token-Encoded Image

(71) Applicant: Adeel Arif, Bensalem, PA (US)

(72) Inventor: Adeel Arif, Bensalem, PA (US)

(73) Assignee: KOOBECAFE, LLC, Lansdale, PA (US)

(21) Appl. No.: 14/713,957

(22) Filed: May 15, 2015

Related U.S. Application Data
(60) Provisional application No. 61/993,518, filed on May 15, 2014.

(51) Int. Cl. G06Q 20/38; G06Q 20/40; G06K 9/46; G06K 9/52; G06T 7/60; G06T 7/40; H04L 29/06; G06K 9/62

(52) U.S. Cl. CPC G06Q 20/3821; H04L 63/083; G06Q 20/4014; G06K 9/6201; G06K 9/52; G06T 7/60; G06T 7/408; G06K 9/4652; G06T 2207/20024; G06K 2009/4666

(57) ABSTRACT

In one embodiment, a computer-implemented electronic commerce transaction method. The computer receives original image data from a user device, associates a security token with the user, embeds the security token into the original image data to generate modified image data, and provides the modified image data to the user device. To authorize a financial transaction that uses personal data of the user, the computer subsequently receives the modified image data from the user device, extracts the security token from the modified image data, and validates the user and/or the user device.

### CROSS-REFERENCE TO RELATED APPLICATION

This application claims priority to co-pending U.S. Provisional Patent Application Ser. No. 61/993,518, filed May 15, 2014, the disclosure of which is incorporated herein by reference in its entirety.

### FIELD OF THE DISCLOSURE

The present disclosure relates generally to electronic commerce, and, in particular, to enhancing security in electronic commerce transactions.

### BACKGROUND

The Internet today comprises billions of computers, tablets and mobile devices connected to each other via a plurality of distributed interconnected networks over HTTP/HTTPS. These interconnected devices exchange information and perform electronic transactions through web services hosted on a server system. Web services are especially conducive to conducting electronic commerce, enabling vendors to sell physical and virtual goods. Conventionally, a server system provides an electronic catalog of products available for purchase, and a user of these web services who is a potential purchaser can browse through the catalog and purchase items.

Since purchaser-specific order information contains sensitive data, such as credit card numbers, both vendors and purchasers want to ensure the security of the information. Security is also a concern because information may pass through several interconnected computers on its way to its final destination. To help ensure the security of the information, various encryption techniques are used when transmitting information between systems. Nevertheless, there is always a possibility that sensitive information can be intercepted and decrypted by the hacker. Therefore, it is desirable to minimize the sensitive information transferred. Today, the number of transactions executed on mobile devices is growing exponentially, and it is becoming ever more important to reduce the steps of the process and the amount of information being transferred for each transaction. Not only is it cumbersome for a user to enter credit card information, mailing, and shipping addresses on his or her mobile device, but such information can also be intercepted right on the mobile device, such as by a rogue mobile application executing in the background or other malware.

### SUMMARY OF THE INVENTION

In one embodiment, the present invention provides a computer-implemented electronic commerce transaction method. The method includes: (a) the computer receiving original image data from a user device; (b) the computer associating a security token with the user; (c) the computer embedding the security token into the original image data to generate modified image data; and (d) the computer providing the modified image data to the user device.

In another embodiment, the present invention provides a computer-implemented method for validating a user or user device. The method includes: (a) the computer receiving, from a user device, modified image data; (b) the computer extracting a security token from the modified image data; and (c) the computer validating at least one of the user and the user device.

In a further embodiment, the present invention provides a server including a processor adapted to: (a) receive original image data from a user device; (b) associate a security token with the user; (c) embed the security token into the original image data to generate modified image data; and (d) provide the modified image data to the user device.

In still a further embodiment, the present invention provides a server including a processor adapted to: (a) receive, from a user device, modified image data; (b) extract a security token from the modified image data; and (c) validate at least one of the user and the user device.

### BRIEF DESCRIPTION OF THE DRAWINGS

FIG. 1 is a flowchart illustrating a process for token encoding onto an image, in one embodiment of the invention;

FIG. 2 is a flowchart illustrating a process for image decoding and validation of a token, in one embodiment of the invention;

FIG. 3 is a process flow diagram illustrating a process for performing an electronic commerce transaction using an encoded image, in one embodiment of the invention;

FIG. 4 illustrates exemplary screen views of a method for employing an encoded image object as a checkout mechanism in a third-party application, in one embodiment of the invention; and

FIG. 5 illustrates an exemplary screen view of an electronic commerce checkout process executed via drag-and-drop of an encoded buy image object, in one embodiment of the invention.

### DETAILED DESCRIPTION

The present invention provides a method and a system for facilitating an electronic commerce transaction or purchase authorization by simply dropping an encrypted steganographed image on the item to be purchased, i.e., using a drag-and-drop action familiar to most users. In one embodiment, the image is unique to the user and is tied to a single device, such as a computer or smartphone. In one embodiment, the user's consent to authorize a transaction is transmitted to the server system over Hypertext Transfer Protocol Secure (HTTPS). In one embodiment, the server system decodes the image to retrieve the security token. Upon successful user authentication the authorized transaction is executed.

### Image Encoding and Decoding

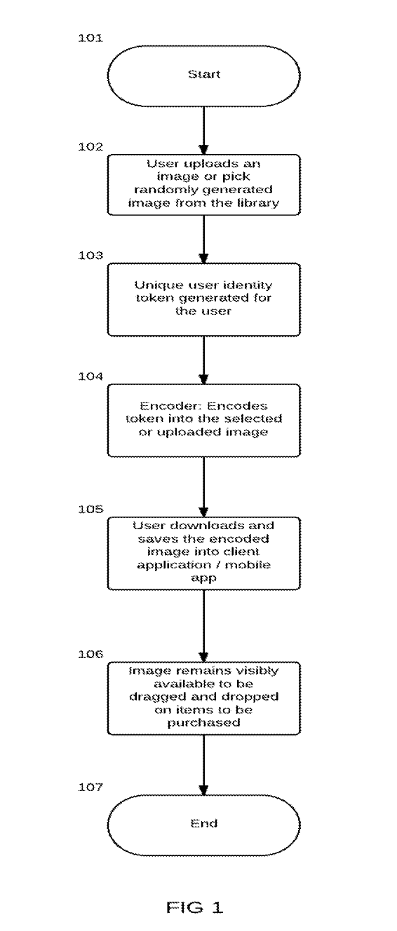

FIG. 1 shows a process for token encoding onto an image, in one embodiment of the invention, which begins at step 101. At step 102, the user uploads an image or chooses a randomly-generated image from a library of images. At step 103, a unique security token associated with the user's identity is generated. At step 104, the encoder embeds the user's unique security token into the image selected or uploaded by the user. The result is a new image with the security token embedded therein. The image file is modified such that the embedded code is not detectable to the human eye, but it can be detected through a decoding module on the server system. At step 105, the user downloads and saves the image file containing the embedded code into his or her client application, mobile application, or the like. At step 106, the stored encoded image is made available to user for transaction authorization through a drag-and-drop process in a graphical user interface (GUI). In one embodiment, a token is generated using a hashing algorithm, which employs a hash code or key generated based on features contained within the image, such as locations of identifiable objects (e.g., eyes and noses of human subjects), shapes of objects (e.g., a binary mask or chain code of an object in an image), the inertia of an image, a low-pass filtering of an image, the Most Significant Bit of every pixel in a selected color plane (luminance, chrominance, Red, Green, Blue, etc.), or the like.

In one embodiment, the following pseudocode may be used to implement a process for encoding a security token onto an image:

module encode_token_onto_image( )

call receive_image_from_user
call generate_security_token (user_id)
call embed_security_token (image_data, token)
call send_modified_image_to_user (image_data_modified)
call provide_drag_and_drop_gui (image_data_modified)

end module
module receive_image_from_user( )

get image_data
get user_id

end module
module generate_security_token

use user_id
call hash_routine (user_id, image_data)
return token

end module
module embed_security_token

use image_data
use token
return image_data_modified

end module
module send_modified_image_to_user( )

use image_data_modified
send image_data_modified to user

end module
module provide_drag_and_drop_gui( )

use image_data_modified
enable user drag and drop

end module
module hash_routine

use user_id
use image_data
hash user_id with image_data
return token

end module

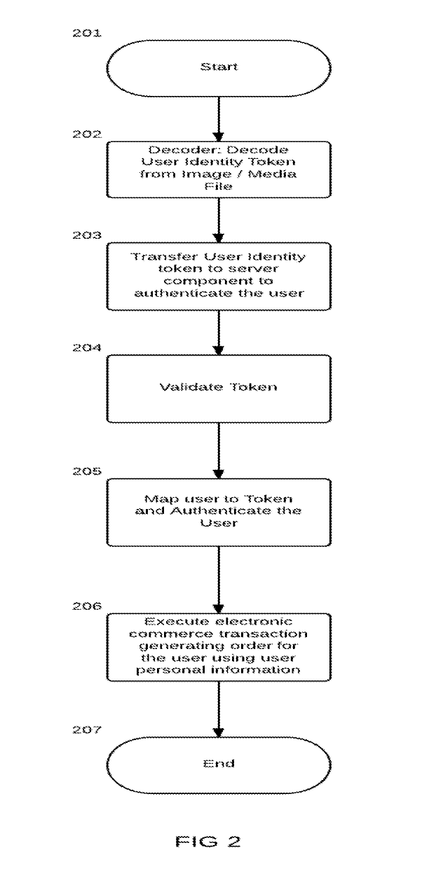

FIG. 2 illustrates image decoding and validation of a token, in one embodiment of the invention, which begins at step 201. At step 202, decoding of the image file by an application or decoder process is performed to authenticate the user's identity, which extracts the token from the received image. At step 203, the application or decoder process transfers the token to the server component to validate the user. At step 204, the token is validated. At step 205, the image file is used to perform further user-level and/or device-level validation, which is performed in two substeps in this exemplary embodiment (although alternative embodiments may employ only one substep or different substeps): In the first substep, the hash extracted from the image file is compared with the hash code associated with the user. In the second substep, a second layer of validation is performed by comparing the Unique Device ID (UDID) of the device from which the transaction is triggered with the UDID associated with the encoded image. The objective for having double validation is to employ a device-dependent parameter that limits the transaction to the device with which the encoded image is associated.

Additional levels of security may be added using a public-key encryption method to create a digital signature using one or more cryptography techniques such as RSA, DES, IDEA (international Data Encryption Algorithm), Skipjack or other block cipher techniques, discrete log systems (e.g., El Gamal Cipher), elliptic curve systems, cellular automata, etc. Public key cryptography systems may be used to implement a private and public key combination for additional security, in some embodiments of the invention.

Once validation and authentication has been completed, at step 206, the electronic commerce transaction generates an order for the user using his or her personal information. The process terminates at step 207.

It should be understood that, in alternative embodiments, routines other than electronic commerce transactions are possible at step 206. For example, the method of steps 201-205 could be used to implement a user login process at step 206, such that a user authenticates himself or herself by dragging-and-dropping an encoded image as described above, instead of using a password, or biometric method, or the like.

In one embodiment, the following pseudocode may be used to implement a process for image decoding and token validation:

module decode_token_from_modified_image

call extract_token (image_data_modified)
call transfer_token_to_server_component (extracted_token)
call validate_token (extracted_token)

if true_flag is 1 then

call generate_order
generate success message

else generate error message

end module
module extract_token

use image_data_modified
return extracted_token

end module
module transfer_token_to_server_component( )

use extracted_token
send extracted_token to server

end module
module validate_token

use extracted_token
extract hash code from image_data_modified
verify that hash code from image_data_modified matches hash code
for user
get unique_device_id_of_device_initiating_transaction

if unique_device_id_of_device_initiating_transaction

matches
unique_device_id _of_image_data_modified then return true_flag
end module
module generate_order( )

get user_id
use user_id to look up user personal_information
generate order using personal_information

end module

### E-Commerce Transaction Flow Using Encoded Image Object

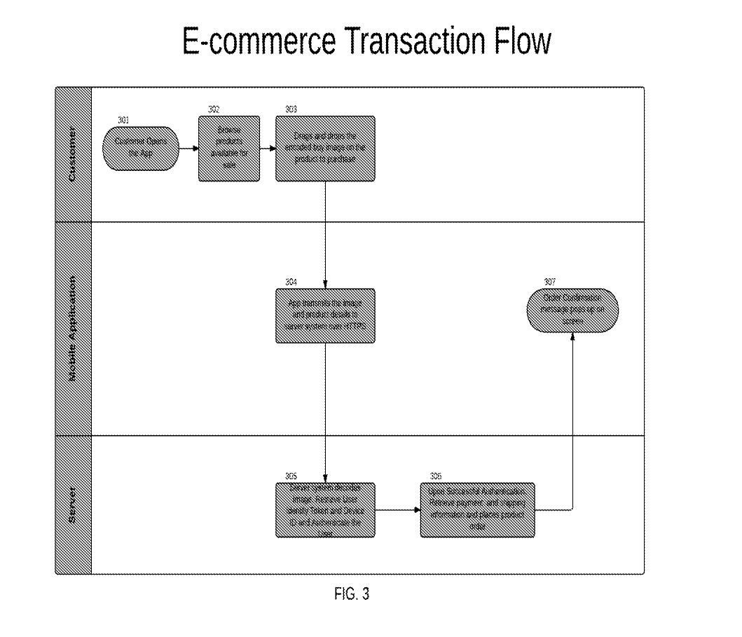

FIG. 3 is a process flow diagram of a routine that enables a commerce transaction by the user simply dragging and dropping an Encoded Buy Image (EBI) over a product that the user wants to purchase. To enable a product purchase via dragging and dropping an EBI object over the product to be purchased, the server system employs information about, the user to complete the purchase order, which may include, e.g., payment type and method, and the user's shipping and billing address. The server system can obtain this information in various ways. For example, the server system can ask the user if he or she would like to enable EBI-based purchases. If the user opts in, then the user can provide all of the required information via a web-based form.

First, at step 301, the customer opens a client application that enables the customer to select items to purchase, and subsequently to purchase those items. At step 302, the user browses products available for sale. At step 303, to initiate a purchase, the user drops an EBI object over the product that the user wishes to purchase. At step 304, the client application sends the image, Unique Device ID (UDID), and product details to the server system over a secure (e.g., HTTPS) connection. At step 305, the server system decodes the image to retrieve the security token, compares the hash code of the security token with the hash code saved in the database server, and also compares the Unique Device ID of the user's device from which the transaction was initiated with the UDID associated with the encoded image. If the hash codes and the UDIDs match, then the user's identity is authenticated. At step 306, once the identity of the user has been authenticated, the user's payment, billing, and shipping information is retrieved from the database, and the order is placed. At step 307, a pop-up message is displayed to the user. If the payment is successfully processed and the process of placing the order is successful, then the pop-up message states that the order has successfully been placed. If the payment information fails, if the product is out of stock, or if the order is not successfully completed for some other reason, then the pop-up message slates that the order was not successful, and a message indicating the reason for the failure is displayed to the user.

In one embodiment, the following pseudocode may be used to implement a process for enabling a commerce transaction by the user simply dragging and dropping an Encoded Buy Image (EBI) over a product that the user wants to purchase:

module enable_transaction

call client_purchase_application

end module
module client_purchase_application

call permit_user_browsing

if browsing results in drag-and-drop operation of image then

call contact_server
get image from drag-and-drop operation
get unique_device_id_of_device_initiating_transaction
get purchased_product_details
send image from drag-and-drop operation,

unique_device_id_of_device_initiating_transaction, and
purchased_product_details to server

receive security token decoded by server
call extract_token2 (image_data_modified)
call transfer_token_to_server_component2
(extracted_token)
call validate_token2 (extracted_token)

if true_flag is 1 then

call generate_order2
generate success message

else generate error message

module extract_token2

use image_data_modified
return extracted_token

end module
module transfer_token_to_server_component2( )

use extracted_token
send extracted_token to server

end module
module validate_token2

use extracted_token
extract hash code from image_data_modified
verify that hash code from image_data_modified matches hash
code for user
get unique_device_id_of_device_initiating_transaction

if unique_device_id_of_device_initiating_transaction

matches
unique_device_id _of_image_data_modified then return true_flag
end module
module generate_order2( )

get user_id
use user_id to look up user personal_information
generate order using personal_information

end module

Encoded Buy Image as Checkout for Third-Party Applications and Mobile Apps:

In one embodiment, the Encoded Buy Image (EBI) object is used to pay for purchases within a third-party application.

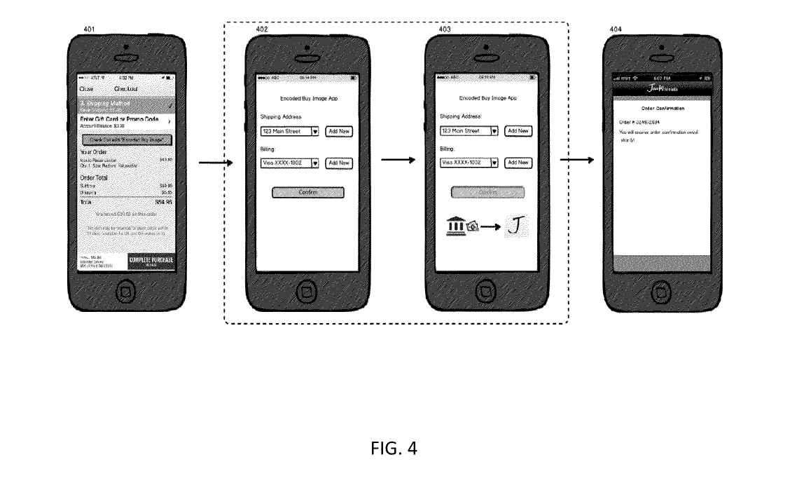

FIG. 4 illustrates screen views of one example of such a process. As shown in screen view 401, when a user selects the option to checkout using an EBI object, the third-party application launches the EBI object application and prompts the user to confirm his or her shipping and billing information, as shown in screen view 402. As shown in screen view 403, once the user confirms his or her shipping and billing information, the EBI object, along with the Unique Device ID, the amount to be charged, and the security token for the third party commerce application, are all sent to the server system. The server system processes the payment, e.g., as illustrated in FIG. 3. In this scenario, money is transferred to an account associated with the third-party application, and the user is re-directed back to the third-party application, where, as shown in screen view 404, the user receives order confirmation information.

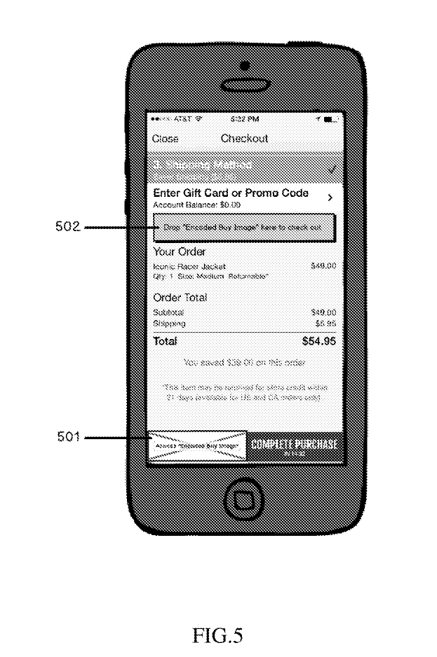

FIG. 5 illustrates a scenario in which the process flow described in FIG. 4 may be automated, if the user allows the third-party application to access the Encoded Buy Image object stored locally on his or her device. In this scenario, the user completes the order by dragging and dropping the EBI object onto a specified portion 502 of the screen, and once the image is dropped, the payment-processing workflow is triggered. The user can still change his or her billing and shipping information by pressing and holding down on the EBI object 501 within the screen view for 2 seconds. Holding down the EBI object 501 for 2 seconds launches the EBI object application, allowing the user to change his or her shipping and billing information for that purchase.

In order to offer EBI object-based checkout, the third-party application initially establishes a Merchant account with the server system and requests secure API access for the integration of EBI objects.

### Use with Other Content Types

The above-described method for encoding and decoding, as illustrated in FIGS. 1-5, can also be implemented with other content types, such as three-dimensional/two-dimensional graphics, animation, audio, and video content, and one or more security tokens employed can include audio and/or visual features of the content.

The encoded media signals can also act as persistent links to metadata stored elsewhere, such as a metadata database server on the Internet, or some other wired or wireless network. Applications for viewing and playing content can display metadata by extracting the link and querying a metadata database server to return the metadata (e.g., access to promotions or premium content). The decoder or an application program in communication with the decoder can issue the query over the Internet using standard communication protocols such as TCP/IP, database standards such as ODBC, and metadata standards such as XML. The query may be sent to a metadata router that maps the link to a metadata database server, which, in turn, returns the metadata to the viewing application for display to the user. This can allow the metadata server to dynamically manage access to special offers and premium content, such that a premium image token holder can automatically decode and access the premium content, while others are not able to see that content.

Only exemplary embodiments of the present invention and a few examples of its versatility are shown and described in the present disclosure. It is to be understood that the present invention is capable of use in various other combinations and environments and is capable of changes or modifications within the scope of the inventive concept as expressed herein.

Different embodiments of the invention may be adaptable for different and specialized purposes. Embodiments of the invention may include implementation of a system on a shared server or in a hardened appliance and may be adapted, e.g., to permit the implementation of the invention across servers on the Internet or in a large heterogeneous environment, such as a private cloud.

It should also be understood that software and/or hardware consistent with embodiments of the invention can be employed, e.g., at endpoint nodes of a network, centrally within a network, as part of a network node, between a standalone pair of interconnected devices not networked to other devices, at a user's end, at the server end, or at any other location within a scheme of interconnected devices.

It should be understood that appropriate hardware, software, or a combination of both hardware and software is provided to effect the processing described above, in the various embodiments of the invention. It should further be recognized that a particular embodiment might support one or more of the modes of operation described herein.

It should be understood that various changes in the details, materials, and arrangements of the parts which have been described and illustrated in order to explain the nature of embodiments of the invention may be made by those skilled in the art without departing from the scope of the disclosure. For example, it should be understood that the inventive concepts of embodiments of the invention may be applied not only in systems and devices for authenticating users in connection with performing e-commerce and other financial transactions, but also in other applications for which embodiments of the invention may have utility.

Embodiments of the present invention can take the form of methods and apparatuses for practicing those methods. Such embodiments can also take the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing embodiments of the invention. Embodiments of the invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing embodiments of the invention. When implemented on a general-purpose processor or custom specific processors, the program code segments combine with the processor to provide a unique device that operates analogously to specific logic circuits. The program code may also be implemented in a cloud computing infrastructure or other distributed computing arrangement that involves a large number of computers connected through a communication network such as the Internet, e.g., a software as a service (SaaS) infrastructure, a platform as a service (PaaS) infrastructure, or an infrastructure as a service (IaaS) infrastructure, and may be implemented in a “Big Data” infrastructures, i.e., collections of data sets too large for traditional analytical methods, such as technology segments that employ platforms such as Apache™ Hadoop, Apache™ Storm, Apache™ Tez, the High Performance Computing Cluster (HPCC) Systems Platform, or the like.

It will be appreciated by those skilled in the art that although the functional components of the exemplary embodiments of the system described herein may be embodied as one or more distributed computer program processes, data structures, dictionaries and/or other stored data on one or more conventional general-purpose computers (e.g., IBM-compatible, Apple Macintosh, and/or RISC microprocessor-based computers), mainframes, minicomputers, conventional telecommunications (e.g., modem, T1, fiber-optic line, DSL, satellite and/or ISDN communications), memory storage means (e.g., RAM, ROM) and storage devices (e.g., computer-readable memory, disk array, direct access storage) networked together by conventional network hardware and software (e.g., LAN/WAN network backbone systems and/or Internet), other types of computers and network resources may be used without departing from the present invention. One or more networks discussed herein may be a local area network, wide area network, internet, intranet, extranet, proprietary network, virtual private network, a TCP/IP-based network, a wireless network (e.g., IEEE 802.11 or Bluetooth), an e-mail based network of e-mail transmitters and receivers, a modem-based, cellular, or mobile telephonic network, an interactive telephonic network accessible to users by telephone, or a combination of one or more of the foregoing.

Embodiments of the invention as described herein may be implemented in one or more computers residing on a network transaction server system, and input/output access to embodiments of the invention may include appropriate hardware and software (e.g., personal and/or mainframe computers provisioned with Internet wide area network communications hardware and software (e.g., CQI-based, FTP, Netscape Navigator™, Mozilla Firefox™, Microsoft Internet Explorer™, Google Chrome™, or Apple Safari™ HTML Internet-browser software, and/or direct real-time or near-real-time TCP/IP interfaces accessing real-time TCP/IP sockets) for permitting human users to send and receive data, or to allow unattended execution of various operations of embodiments of the invention, in real-time and/or batch-type transactions. Likewise, a system consistent with the present invention may include one or more remote Internet-based servers accessible through conventional communications channels (e.g., conventional telecommunications, broadband communications, wireless communications) using conventional browser software (e.g., Netscape Navigator™, Mozilla Firefox™, Microsoft Internet Explorer™, Google Chrome™, or Apple Safari™). Thus, embodiments of the present invention may be appropriately adapted to include such communication functionality and Internet browsing ability. Additionally, those skilled in the art will recognize that the various components of the server system of the present invention may be remote from one another, and may further include appropriate communications hardware/software and/or LAN/WAN hardware and/or software to accomplish the functionality herein described.

Each of the functional components of embodiments of the present invention may be embodied as one or more distributed computer-program processes running on one or more conventional general purpose computers networked together by conventional networking hardware and software. Each of these functional components may be embodied by running distributed computer-program processes (e.g., generated using “full-scale” relational database engines such as IBM DB2™, Microsoft SQL Server™, Sybase SQL Server™, or Oracle 10g™ database managers, and/or a JDBC interface to link to such databases) on networked computer systems (e.g., including mainframe and/or symmetrically or massively-parallel computing systems such as the IBM SB2™ or HP 9000™ computer systems) including appropriate mass storage, networking, and other hardware and software for permitting these functional components to achieve the stated function. These computer systems may be geographically distributed and connected together via appropriate wide- and local-area network hardware and software. In one embodiment, data stored in the database or other program data may be made accessible to the user via standard SQL queries for analysis and reporting purposes.

Primary elements of embodiments of the invention may be server-based and may reside on hardware supporting an operating system such as Linux, Microsoft Windows NT/2000™ or UNIX.

Components of a system consistent with embodiments of the invention may include mobile and non-mobile devices. Mobile devices that may be employed in embodiments of the present invention include personal digital assistant (PDA) style computers, e.g., as manufactured by Apple Computer, Inc. of Cupertino, Calif., or Palm, Inc., of Santa Clara, Calif., and other computers running the Android, Symbian, RIM Blackberry, Palm webOS, or iPhone operating systems, Windows CE™ handheld computers, or other handheld computers (possibly including a wireless modem), as well as wireless, cellular, or mobile telephones (including GSM phones, J2ME and WAP-enabled phones, Internet-enabled phones and data-capable smart phones), one- and two-way paging and messaging devices, laptop computers, etc. Other telephonic network technologies that may be used as potential service channels in a system consistent with embodiments of the invention include 2.5G cellular network technologies such as GPRS and EDGE, as well as 3G technologies such as CDMA1×RTT and WCDMA2000, and 4G technologies. Although mobile devices may be used in embodiments of the invention, non-mobile communications devices are also contemplated by embodiments of the invention, including personal computers, Internet appliances, set-top boxes, landline telephones, etc. Clients may also include a PC that supports Apple Macintosh™, Microsoft Windows 95/98/NT/ME/CE/2000/XP/Vista/7/B™, a UNIX Motif workstation platform, Linux, or other computer capable of TCP/IP or other network-based interaction. In one embodiment, no software other than a web browser may be required on the client platform.

Alternatively, the aforesaid functional components may be embodied by a plurality of separate computer processes (e.g., generated via dBase™, Xbase™, MS Access™ or other “flat file” type database management systems or products) running on IBM-type, Intel Pentium™ or RISC microprocessor-based personal computers networked together via conventional networking hardware and software and including such other additional conventional hardware and software as may be necessary to permit these functional components to achieve the stated functionalities. In this alternative configuration, since such personal computers typically may be unable to run full-scale relational database engines of the types presented above, a non-relational flat file “table” (not shown) may be included in at least one of the networked personal computers to represent at least portions of data stored by a system according to embodiments of the present invention. These personal computers may run the Unix, Linux, Microsoft Windows NT/2000™ or Windows 95/98/NT/ME/CE/2000/XP/Vista/7/8™ operating systems. The aforesaid functional components of a system according to the invention may also include a combination of the above two configurations (e.g., by computer program processes running on a combination of personal computers, RISC systems, mainframes, symmetric or parallel computer systems, and/or other appropriate hardware and software, networked together via appropriate wide- and local-area network hardware and software).

A system according to embodiments of the present invention may also be part of a larger system including multi-database or multi-computer systems or “warehouses” wherein other data types, processing systems (e.g., transaction, financial, administrative, statistical, data extracting and auditing, data transmission/reception, and/or accounting support and service systems), and/or storage methodologies may be used in conjunction with those of the present invention to achieve additional functionality.

In one embodiment, source code may be written in an object-oriented programming language using relational databases. Such an embodiment may include the use of programming languages such as C++ and toolsets such as Microsoft's.Net™ framework. Other programming languages that may be used in constructing a system according to embodiments of the present invention include Java, HTML, Perl, UNIX shell scripting, assembly language, Fortran, Pascal, Visual Basic, and QuickBasic. Those skilled in the art will recognize that embodiments of the present invention may be implemented in hardware, software, or a combination of hardware and software.

Accordingly, the terms “server,” “computer,” and “system,” as used herein, should be understood to mean a combination of hardware and software components including at least one machine having a processor with appropriate instructions for controlling the processor. The singular terms “server,” “computer,” and “system” should also be understood to refer to multiple hardware devices acting in concert with one another, e.g., multiple personal computers in a network; one or more personal computers in conjunction with one or more other devices, such as a router, hub, packet-inspection appliance, or firewall; a residential gateway coupled with a set-top box and a television; a network server coupled to a PC; a mobile phone coupled to a wireless hub; and the like. The term “processor” should be construed to include multiple processors operating in concert with one another.

It should also be appreciated from the outset that one or more of the functional components may alternatively be constructed out of custom, dedicated electronic hardware and/or software, without departing from the present invention. Thus, embodiments of the invention are intended to cover all such alternatives, modifications, and equivalents as may be included within the spirit and broad scope of the disclosure.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

It will be further understood that various changes in the details, materials, and arrangements of the parts which have been described and illustrated in order to explain the nature of this disclosure may be made by those skilled in the art without departing from the scope of the disclosure as expressed in the following claims.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A computer-implemented electronic commerce transaction method comprising:
(a) the computer receiving original image data from a user device;
(b) the computer associating a security token with the user;
(c) the computer embedding the security token into the original image data to generate modified image data; and
(d) the computer providing the modified image data to the user device.

2. The method of claim 1, further comprising:
(e) the computer receiving, from the user device, the modified image data;
(f) the computer extracting the security token from the modified image data; and
(g) the computer validating at least one of the user and the user device.

3. The method of claim 2, wherein step (g) comprises either or both of:
(A) (1) the computer extracting a hash from the modified image data; and
(2) the computer comparing the hash from the modified image data with a hash code associated with one or both of the original image data and the user; and
(B) the computer comparing a Unique Device ID (UDID) associated with one or both of the original image data and the user device, with a UDID associated with the modified image data.

4. The method of claim 3, further comprising:
the computer generating the hash code based on at least one of:
one or more features contained within the image;
locations of one or more identifiable objects in the image;
shapes of one or more objects in the image;
inertia of an image;
low-pass filtering of an image; and
the most significant bits of one or more pixels in one or more selected color planes.

5. The method of claim 1, further comprising:
the computer using a public-key encryption method to create a digital signature using one or more cryptography techniques.

6. The method of claim 2, further comprising:
after step (d) and prior to step (e), the computer associating, with the user, personal data of the user; and
after step (g), the computer authorizing an electronic commerce transaction that uses at least a portion of the personal data of the user.

7. The method of claim 1, wherein step (a) comprises at least one of (i) the computer receiving an image uploaded by a user, and (ii) the computer receiving a selection of an image by the user.

8. The method of claim 1, wherein the modified image data and the original image data appear to be substantially identical in appearance to the human eye.

9. A computer-implemented method for validating a user or user device comprising:
(a) the computer receiving, from a user device, modified image data;
(b) the computer extracting a security token from the modified image data; and
(c) the computer validating at least one of the user and the user device.

10. The method of claim 9, wherein step (c) comprises either or both of:
(A) (1) the computer extracting a hash from the modified image data; and
(2) the computer comparing the hash from the modified image data with a hash code associated with one or both of the original image data and the user; and
(B) the computer comparing a Unique Device ID (UDID) associated with one or both of the original image data and the user device, with a UDID associated with the modified image data.

11. The method of claim 10, further comprising:
the computer extracting the hash based on at least one of:
one or more features contained within the image;
locations of one or more identifiable objects in the image;
shapes of one or more objects in the image;
inertia of an image;
low-pass filtering of an image; and
the most significant bits of one or more pixels in one or more selected color planes.

12. The method of claim 9, further comprising:
the computer using a public-key encryption method to verify a digital signature using one or more cryptography techniques.

13. The method of claim 9, further comprising:
after step (c), the computer authorizing an electronic commerce transaction that uses at least a portion of stored personal data associated with the user.

14. The method of claim 9, wherein the modified image data and the original image data appear to be substantially identical in appearance to the human eye.

15. A server comprising a processor adapted to:
(a) receive original image data from a user device;
(b) associate a security token with the user;
(c) embed the security token into the original image data to generate modified image data; and
(d) provide the modified image data to the user device.

16. The server of claim 15, wherein the processor is further adapted to:
(e) receive, from the user device, the modified image data;
(f) extract the security token from the modified image data; and
(g) validate at least one of the user and the user device.

17. The server of claim 16, wherein step (g) comprises either or both of:
(A) (1) the processor extracting a hash from the modified image data; and
(2) the processor comparing the hash from the modified image data with a hash code associated with one or both of the original image data and the user; and
(B) the processor comparing a Unique Device ID (UDID) associated with one or both of the original image data and the user device, with a UDID associated with the modified image data.

18. The server of claim 17, wherein the processor is further adapted to:
generate the hash code based on at least one of:
one or more features contained within the image;
locations of one or more identifiable objects in the image;
shapes of one or more objects in the image;
inertia of an image;
low-pass filtering of an image; and
the most significant bits of one or more pixels in one or more selected color planes.

19. The server of claim 15, wherein the processor is further adapted to use a public-key encryption method to create a digital signature using one or more cryptography techniques.

20. The server of claim 16, wherein the processor is further adapted:
after step (d) and prior to step (e), to associate, with the user, personal data of the user; and
after step (g), authorize an electronic commerce transaction that uses at least a portion of the personal data of the user.

21. The server of claim 15, wherein step (a) comprises at least one of (i) receiving an image uploaded by a user, and (ii) receiving a selection of an image by the user.

22. The server of claim 15, wherein the modified image data and the original image data appear to be substantially identical in appearance to the human eye.

23. A server comprising a processor adapted to:
(a) receive, from a user device, modified image data;
(b) extract a security token from the modified image data; and
(c) validate at least one of the user and the user device.

24. The server of claim 23, wherein step (c) comprises either or both of:
(A) (1) the processor extracting a hash from the modified image data; and
(2) the processor comparing the hash from the modified image data with a hash code associated with one or both of the original image data and the user; and
(B) the processor comparing a Unique Device ID (UDID) associated with one or both of the original image data and the user device, with a UDID associated with the modified image data.

25. The server of claim 24, wherein the processor is further adapted to:
extract the hash based on at least one of:
one or more features contained within the image;
locations of one or more identifiable objects in the image;
shapes of one or more objects in the image;
inertia of an image;
low-pass filtering of an image; and
the most significant bits of one or more pixels in one or more selected color planes.

26. The server of claim 23, wherein the processor is further adapted to:
use a public-key encryption method to verify a digital signature using one or more cryptography techniques.

27. The server of claim 23, wherein the processor is further adapted to authorize, after step (c), an electronic commerce transaction that uses at least a portion of stored personal data associated with the user.

28. The server of claim 23, wherein the modified image data and the original image data appear to be substantially identical in appearance to the human eye.
